(19) United States
(12) Patent Application Publication
(10) Pub. No.: US 2008/0162234 A1
(43) Pub. Date: Jul. 3, 2008

(54) TIME ZONE SWITCHER FOR MULTI-JURISDICTIONAL END USERS

(76) Inventors: Fang Lu, Billerica, MA (US); Weichuan Dong, Lowell, MA (US)

Correspondence Address: CAREY, RODRIGUEZ, GREENBERG & PAUL, LLP;STEVEN M. GREENBERG, 950 PENINSULA CORPORATE CIRCLE, SUITE 3020, BOCA RATON, FL, 33487, US

(21) Appl. No.: 11/616,548

(22) Filed: Dec. 27, 2006

(51) Int. Cl. G06Q 10/00

(52) U.S. Cl. 705/8

(57) ABSTRACT

Embodiments of the present invention address deficiencies of the art in respect to time zone management for calendaring and scheduling (C&S) systems and provide a method, system and computer program product for flexible time zone switching in a C&S system. In one embodiment of the invention, a flexible time zone switching method for C&S systems can be provided. The method can include setting a first time zone for a future time segment in a C&S system. Thereafter, a specified time and date can be proposed in a second time zone for an event to be calendared in the C&S system. Subsequently, it can be determined whether the specified date falls within the future time segment. If so, the specified time in the second time zone can be converted to an equivalent time in the first time zone. Finally, the event can be calendered in the C&S system.

### BACKGROUND OF THE INVENTION

1. Field of the Invention

The present invention relates to the field of calendaring and scheduling systems and more particularly to the field of time zone processing when scheduling meetings, activities or appointments in a calendaring or scheduling system.

2. Description of the Related Art

Calendaring systems have formed the core component of personal information management software and firmware applications for decades. Initially, a mere calendar display, modern calendaring systems provide scheduling and alarm functions in addition to full integration with contact management, time entry, billing and project management applications. The typical calendaring application minimally provides a mechanism for scheduling an event to occur on a certain date at a certain time. Generally, the event can be associated with a textual description of the event. More advanced implementations also permit the association of the scheduled event with a particular contact, a particular project, or both. Furthermore, most calendar applications provide functionality for setting an alarm prior to the occurrence of the event, as well as archival features.

Several software products include support for Calendaring & Scheduling (C&S). Known C&S products include Lotus™ Notes™, Microsoft™ Outlook™, and web-based products like Yahoo!™ Calendar™. These products allow one to manage personal events including appointments and anniversaries. C&S products also typically allow one to manage shared events, referred to generally as meetings. Electronic Calendaring and Scheduling software allows a group of people to negotiate around the scheduling of a proposed event such as a meeting, with the goal of selecting a time that allows most of the group to attend. Finding a common free time slot across multiple calendars can be challenging; but, the challenge can be compounded when different people in the group reside in different time zones.

Notwithstanding, conventional C&S products display date/time values only in respect to the time zone of the person performing the scheduling. In consequence, it can be difficult for the person scheduling an event to acquire an awareness of the typical available hours for all of the invitees to a meeting, since the person scheduling the event must first know the locations and time zones of all of the invitees, and must second compute the overlapping time zones. While this computation can be somewhat convenient where only a small number of familiar time zones are involved, the computation can become intractable when dealing with large numbers of geographies, some of which may be unfamiliar.

Seasoned travelers often travel across different time zones, and schedule work with collaborators located in different time zones. Yet, modern C&S products provide little time zone support and require the end user to mentally calculate the time zone difference between the current time zone and the “target” time zone when scheduling a meeting. If the user does not know with certainty the time differential between the time zone at the place of scheduling and the time zone for the prospective meeting, that information must be researched. Otherwise, scheduling errors will become introduced into the end user calendar.

To cope with the time zone differential problem, advanced forms of modern C&S applications provide the option of displaying two time zones side by side within one calendar view. One time zone represents the local time zone while the other time zone represents the time zone where the future calendar event will occur. To enable this feature, however, requires the end user to set up the desired time zones in advance with preference settings for the C&S system. The preferences limit the end user only to two time zones, however. For frequent travelers crossing multiple different time zones often, those end users must constantly modify the system preferences for the C&S system—an impracticality for most.

### BRIEF SUMMARY OF THE INVENTION

Embodiments of the present invention address deficiencies of the art in respect to time zone management for C&S systems and provide a novel and non-obvious method, system and computer program product for flexible time zone switching in a C&S system. In one embodiment of the invention, a flexible time zone switching method for C&S systems can be provided. The method can include setting a first time zone for a future time segment in a C&S system. Thereafter, a specified time and date can be proposed in a second time zone for an event to be calendared in the C&S system. Subsequently, it can be determined whether the specified date falls within the future time segment. If so, the specified time in the second time zone can be converted to an equivalent time in the first time zone. Finally, the event can be calendered in the C&S system.

In one aspect of the embodiment, setting a first time zone for a future time segment in the C&S system can include setting a first time zone for a future day in the C&S system. In another aspect of the embodiment, setting a first time zone for a future time segment in the C&S system can include setting a first time zone for a future range of days in the C&S system. In yet another aspect of the embodiment, setting a first time zone for a future time segment in the C&S system can include setting a first time zone for a future time range across multiple future days in the C&S system. Finally, in even yet another aspect of the embodiment, setting a first time zone for a future time segment in the C&S system can include setting a first time zone for a future time range for a future day in the C&S system.

In another embodiment of the invention, a C&S data processing system can include a C&S system disposed in a host computing platform configured for coupling to a plurality of computing clients over a computer communications network. The system also can include a data store of calendared events for different users in the C&S system and a list of different time zones. Finally, the system can include a flexible time zone switcher. The switcher can include program code enabled to set a first time zone for a future time segment in the C&S system, to propose a specified time and date in a second time zone for an event to be calendared in the C&S system, to determine whether the specified date falls within the future time segment, and to convert the specified time in the second time zone to an equivalent time in the first time zone when it is determined that the specified time falls within the future time segment.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a pictorial illustration of a C&S system user interface configured for flexible time zone switching;

FIG. 2 is a schematic illustration of a C&S system configured for flexible time zone switching; and,

FIGS. 3A and 3B, taken together, are a flow chart illustrating a process for flexible time zone switching in a C&S system.

### DETAILED DESCRIPTION OF THE INVENTION

Embodiments of the present invention provide a method, system and computer program product for flexible time zone switching in a C&S system. In accordance with an embodiment of the present invention, individual calendar segments can be associated with a specified time zone for a collaborator in the C&S system. The calendar segments can include individual dates, or time ranges across one or more individual dates. Thereafter, events such as meetings and tasks can be calendared for a specified time and date. The specified time, however, can be calendared according to a time zone for the calendar segment into which the specified date falls. In this way, tedious manual adjustments to preferences for the C&S system can be avoided.

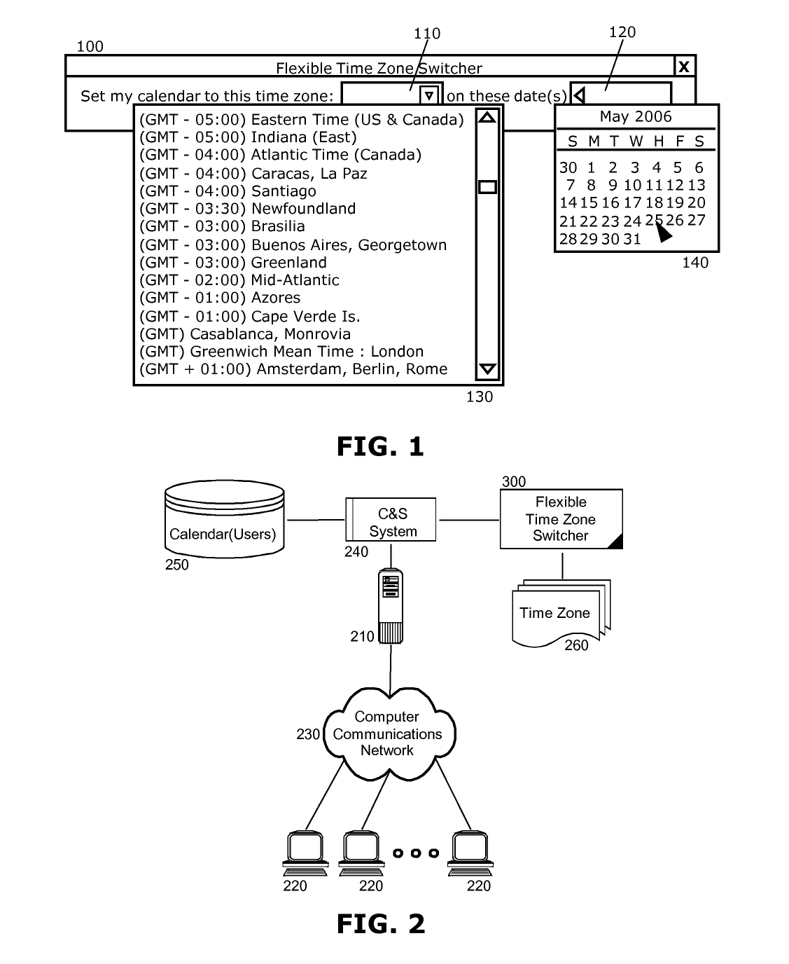

In further illustration, FIG. 1 is a pictorial illustration of a C&S system user interface configured for flexible time zone switching. The C&S system user interface can include a flexible time zone switcher 100. The flexible time zone switcher 100 can include a time zone selection control 110 and a date selection control 120. The time zone selection control 110 can provide for a time zone listing control 130 of available time zones activatable from within the time zone selection control 110. The date selection control 120, in turn, can include a calendar selection control 140 activatable from the date selection control 120 and providing a selection of one or more dates in a date range. Using the flexible time zone switcher 100, an end user can establish a time zone to be used when calendaring events during a time segment defined by the end user through the date selection control 120.

Turning now to FIG. 2, is a schematic illustration is shown of a C&S system configured for flexible time zone switching. The system can include a host computing platform 210 configured for coupling to one or more computing clients 220 over computer communications network 230. The host computing platform 210 can support the operation of a C&S system 240. The C&S system 240, in turn, can be configured to permit individual users through corresponding computing clients 220 to establish individual calendars of events within a data store of calendared events 250 for each user.

Notably, a flexible time zone switcher 300 can be coupled to the C&S system. The flexible time zone switcher 300 can include program code enabled to provide a selection of time zones 260 to a querying end user for application to a specified time segment. The time segment can include a single time range, a single day or multiple day range, or any combination thereof The program code of the flexible time zone switcher 300 further can be enabled to convert a specified time and date for a scheduled event to a different time zone according to whether or not a different time zone is specified for a time segment incorporating the specified time and date.

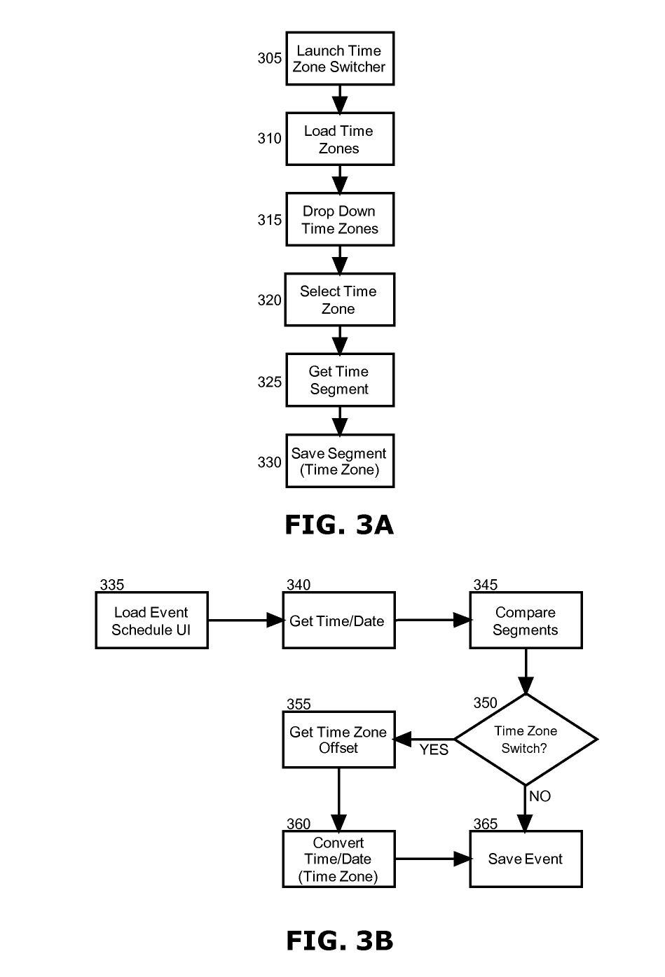

In yet further illustration of the operation of the flexible time zone switcher 300, FIGS. 3A and 3B, taken together, is a flow chart illustrating a process for flexible time zone switching in a C&S system. Beginning in block 305, the time zone switcher can be loaded and rendered and a set of time zones can be loaded for use in the time zone switcher in block 310. In block 315, responsive to the selection of a time zone selection control, the time zones can be rendered in a drop down box through which a single time zone can be selected by an end user in block 320. Concurrently, in block 325 a time segment can be specified, for instance a time range, a single date, a date range or any combination thereof Subsequently, the selected time zone can be stored in association with the specified time segment.

Turning now to FIG. 3B, in block 335, an event scheduling user interface in the C&S system can be loaded and rendered for use by the end user. Using the event scheduling user interface, the end user can schedule an event for a specified date and time. In block 340, the date and time for the event can be specified. Thereafter, in block 345, the specified data and time can be compared to stored time segments to determine whether or not the specified date and time falls within a time segment associated with a different time zone. In this regard, in decision block 350, if the specified date and time is determined to fall within a time segment associated with a different time zone, in block 355 the time zone offset for the different time zone can be determined and in block 360, the specified date and time can be converted to accommodate the different time zone. Finally, in block 365, the event can be calendared for the end user.

Embodiments of the invention can take the form of an entirely hardware embodiment, an entirely software embodiment or an embodiment containing both hardware and software elements. In a preferred embodiment, the invention is implemented in software, which includes but is not limited to firmware, resident software, microcode, and the like. Furthermore, the invention can take the form of a computer program product accessible from a computer-usable or computer-readable medium providing program code for use by or in connection with a computer or any instruction execution system.

For the purposes of this description, a computer-usable or computer readable medium can be any apparatus that can contain, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution. Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

1. In a calendaring and scheduling (C&S) system, a flexible time zone switching method comprising:
setting a first time zone for a future time segment in the C&S system;
proposing a specified time and date in a second time zone for an event to be calendared in the C&S system;
determining whether the specified date falls within the future time segment;
converting the specified time in the second time zone to an equivalent time in the first time zone when it is determined that the specified time falls within the future time segment; and, calendaring the event.

2. The method of claim 1, wherein setting a first time zone for a future time segment in the C&S system, comprises setting a first time zone for a future day in the C&S system.

3. The method of claim 1, wherein setting a first time zone for a future time segment in the C&S system, comprises setting a first time zone for a future range of days in the C&S system.

4. The method of claim 1, wherein setting a first time zone for a future time segment in the C&S system, comprises setting a first time zone for a future time range across multiple future days in the C&S system.

5. The method of claim 1, wherein setting a first time zone for a future time segment in the C&S system, comprises setting a first time zone for a future time range for a future day in the C&S system.

6. The method of claim 4, wherein determining whether the specified date falls within the future time segment, comprises determining whether the specified date and a specified time falls within the future time range across the multiple future days.

7. The method of claim 5, wherein determining whether the specified date falls within the future time segment, comprises determining whether the specified date and a specified time falls within the future time range for the future day.

8-21. (canceled)
